(19) United States
(12) Patent Application Publication
(10) Pub. No.: US 2016/0278304 A1
(43) Pub. Date: Sep. 29, 2016

(54) Apparatus and Method for Accelerating Horticultural Growth with LEDs

(71) Applicant: Neu-Tech, LLC, Terrace Park, OH (US)

(72) Inventor: Christopher J Elsegood, Hanover (CA)

(21) Appl. No.: 15/082,911

(22) Filed: Mar. 28, 2016

Related U.S. Application Data
(60) Provisional application No. 62/139,493, filed on Mar. 27, 2015.

(51) Int. Cl. A01G 9/20; F21V 29/67; F21V 23/04; A01G 7/04; F21V 5/04; F21V 19/00; A01G 1/00; F21V 29/70; F21V 23/02

(52) U.S. Cl. CPC A01G 9/20; F21V 29/70; F21V 29/67; F21V 23/04; F21V 23/02; F21V 5/04; F21V 19/003; A01G 1/001; A01G 7/045; F21Y 2113/005

(57) ABSTRACT

An LED lighting fixture has a plurality of LED units, each of the plurality of LED units has a color and a beam angled associated therewith. The LEDs with different colors are used at different times during a plant's growth cycle to increase the growth of the plant with reduced energy consumption and heat generation. The LEDs may also be put on a strip and all illuminated at the same time.

### REFERENCE TO RELATED CASE

This application claims priority under 35 U.S.C. §119 (e) to provisional application No. 62/139,493 filed on Mar. 27, 2015, the contents of which are hereby incorporated by reference in their entirety.

### BACKGROUND OF THE INVENTION

### Field of the Invention

The invention relates to greenhouse lighting and horticultural lighting. More particularly the invention relates to the adaption of light emitting diodes (LEDs) at specific or targeted wavelengths for horticultural growth. The invention uses an array of LEDs of these wavelengths for all the growth stages required for accelerating horticultural growth.

With LEDs within the horticultural space, light and temperature can be precisely controlled to create a controlled atmosphere for all optimum growth of plant tissue. Natural light is an optimum light within the areas of horticultural light; however, as in many areas, an adaption of artificial light or supplemental light in a particular light range may be required.

Natural light and artificial light have different wavelengths or spectral qualities. There are many different types of artificial light, depending on the light source used and its characteristics. The spectral characteristics can be altered by specific wavelengths from the LEDs. For example, the blue and deep blue wavelengths are used for vegetative stages for plant growth.

A plethora of different lighting systems for plant growth are currently in use. In almost all cases a high amount of light output can be achieved by removing excess heat values in the growing area. As required, the light source can be placed in close proximity to the horticulture targets within the controlled area. Fluctuating temperatures in the growth area can provide significant results. The uses of LEDs within the horticultural area provide nominal temperature while at the same time providing superior growth results.

Very often horticultural lighting systems must deal with excessive heat that accompanies existing technologies. Horticultural lighting systems allow the placement of the sources close to the growth area. Drawbacks of this light is the heat build-up around the light in conjunction with the electrical usage and a lack of pin-point wavelengths of light that is required. The light intensity of LEDs is very high to ensure the maximum rate of photosynthesis is to fully occur and provide the PAR value required. The adoption of LEDs brings in several key advantages over existing illumination technologies for indoor horticulture. LEDs have predicted lifetimes from 50-100.000 hours without significant drops in efficiency and consume less energy. Recent advances with LEDs allow them to be used with customized precise wavelengths for plant growth. However, most of these LEDs and LED growth systems use mixtures of specialized wavelengths emitting into several narrow wavelengths. Testing of the growth of six different plant species under Aluminum PCB coated LED-chips fitted into a growth combination. The LED system was compared with HPS and HID standard lighting systems in the same scenario. Significant differences in heat generation between LEDs and conventional lighting were clearly demonstrated. The LED lights allowed for better control and stability of preset growing conditions. Physiological properties such as growth characteristics, biomass, and chlorophyll content were measured and the responses to pathogens for plant species increased. Specific LEDs provide light very sufficiently, the quality and intensity for plant growth while using less than 80% of the electricity required by the standard lighting under each test. The types of the LED installation provided a simple installation for existing infrastructure for indoor plant growth. Each plant species responded differently to the LED lights so it would be reasonable to test their utility to any particular area of application. The adoption of specific light emitting diodes (LEDs) brings several crucial advantages over existing illumination technologies in regard for indoor plant resources. High pressure sodium lamps or HPS, generated excess heat that must be exhausted from closed environments such as growth rooms and growth chambers, creating additional issues with the control of air-flow, humidity and irrigation.

The present invention also offer very long lifetimes in the ranges of 50-100.000 hours without significant drops in any efficiency and therein do not need to be periodically checked and or replaced. The present invention allows the complete control of the light intensity by managing its particular wavelength which they are driven, mainly in milliamps or Ma. Most LEDs operated on very low voltage direct current (DC), which may offer additional safety benefits within a growing environment as with water and irrigation sources. Advantages in energy-efficient LED-based light sources also had a good safety feature: they do not contain mercury or other hazardous chemicals and can be safely touched without any harm during full operation. The traditional grow lamps, which are currently the most common source of light for indoor plants emit light in several prescribed wavelengths ranging from 400 to 750 nm and are not always in parallel with the wavelengths absorbed by a plant's photosynthetic procedure. Many studies on the plants were usually under red LEDs supplemented into the plant canopy. LEDs of the present invention today are by far the most efficient source as they emit light that corresponds to the absorbance peaks of chlorophyll (660 nm). It is known that LED blue light at the (450 nm) also was important for the signaling of plant development.

Most commercial LED-lights tested adapted narrow band LEDs that are not at all specifically designed and made for the purpose of plant growth. While multiple manufacturers provided LEDs for direct replacements of existing horticulture lighting (e.g. Philips, Osram and others) the light output most of these solutions is not specifically designed to match requirements of plant lighting. The present invention uses sources to match the maximum production values. Selected several model plant species widely used by the plant research community was chosen to test. This group included; Lettuce, Tomato, Barley Wheat and flowers, example; Geraniums, all important species used in plant biology and genetic studies.

Many disadvantages of the current systems are excessive heat output, complexity, costs, and shorter lifespan. Heat values are the most problematic. It is therefore, desirable to provide to provide a horticultural light system which overcomes the disadvantages of the prior art in its design and method.

### SUMMARY OF THE INVENTION

According to one aspect of the present invention, an LED lighting fixture for use to accelerate horticultural growth that includes a first plurality of LEDs for emitting light having a first color, a second plurality of LEDs for emitting light having a second color, a third plurality of LEDs for emitting light having a third color, a fourth plurality of LEDs for emitting light having a fourth color, a each of the plurality of LEDs having a lens associated therewith, each lens having a beam angle of between 15 and 120 degrees, LED drivers associated with each of the plurality of LEDs, at least one heat sink to remove heat from the plurality of LEDs; and at least one fan to directed to the at least one heat sink.

In some embodiments, the colors for each of the plurality of LEDs are selected from the group of colors consisting of blue, red, orange, turquoise, far red, and white.

In some embodiments, at least some of the pluralities of LEDs are provided on a strip.

In other embodiments, the beam angle for the LEDs is selected from the group of angles consisting of 30, 60, 90 and 120 degrees.

According to another aspect of the present invention, a method of exposing plants to light to accelerate growth of the plants that includes providing a plurality of plants, providing a plurality of light fixtures, each of the plurality of lighting fixtures comprising a first plurality of LEDs for emitting light having a first color, a second plurality of LEDs for emitting light having a second color, a third plurality of LEDs for emitting light having a third color, and a fourth plurality of LEDs for emitting light having a fourth color, and a fifth plurality of LEDs for emitting white light, exposing the plants for a first predetermined time period to light from the plurality of light fixtures, the light having a first color, exposing the plants for a second predetermined time period to light from the plurality of light fixtures, the light having a second color, exposing the plants for a third predetermined time period to light from the plurality of light fixtures, the light having a third color, and exposing the plants for a fourth predetermined time period to light from the plurality of light fixtures, the light having a fourth color.

In some embodiments, the first predetermined time period is 18 days, the second predetermined time period is 28 days, the third predetermined time period is 32 days and the fourth predetermined time period is 12 days.

### BRIEF DESCRIPTION OF THE DRAWINGS

FIG. 1 is a perspective view of one embodiment of an LED lighting fixture for use to accelerate horticultural growth according to the present invention;

FIG. 2 is a schematic of the LED lighting fixture of FIG. 1 illustrating the main components thereof;

FIG. 3 is a schematic of one embodiment of an LED according to the present invention that is used with the LED lighting fixture of FIG. 1;

FIG. 4 is a schematic showing LED fixtures of the present invention mounted over a plurality of plants;

FIG. 5 is a schematic illustrating one layout of LEDs at full spectrum for use with the LED fixture of the present invention;

FIG. 6 is a schematic of one embodiment of a layout of LEDs for the seedling stage of growth according to the present invention;

FIG. 7 is a schematic of one embodiment of a layout of LEDs for the vegetation stage of growth according to the present invention;

FIG. 8 is a schematic of one embodiment of a layout of LEDs for the flowering stage of growth according to the present invention;

FIG. 9 is a schematic of one embodiment of a layout of LEDs for the budding stage of growth according to the present invention;

FIG. 10 is a schematic of another embodiment of an LED lighting fixture for use to accelerate horticultural growth according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

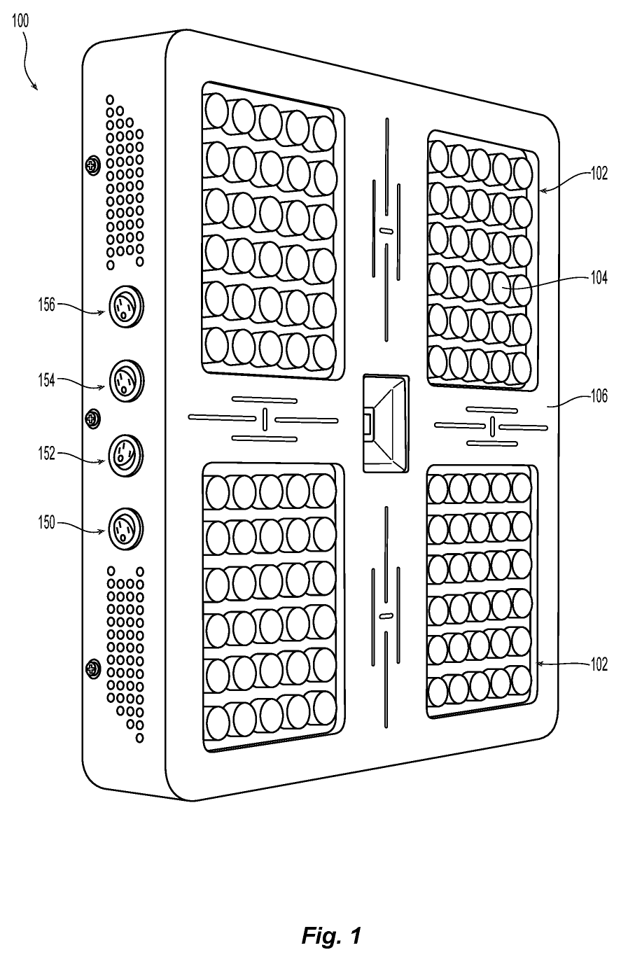

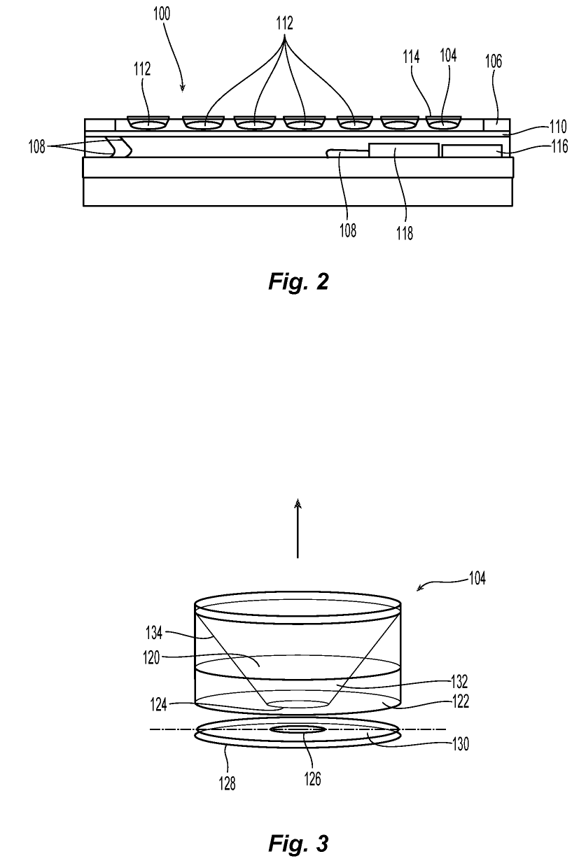

One example of an LED fixture 100 is illustrated in FIG. 1. The LED fixture 100 has four sections 102 of LED units 104 that are secured within an outer case 106 to protect the LEDs and the related hardware (described in more detail below) so as to be used primarily in a horticultural setting. The LED fixture requires the same general components of standard LED fixtures. This includes the LED panels, drivers, heat sink, and cooling mechanisms on the rear of the top of the LED fixture. Turning to FIG. 2, which illustrates a schematic of an LED fixture 100. The LED fixture 100 has an LED power supply 108 to the panel 110. A plurality of LED units 104 are disposed on top of the panel 110 and have an optical system as described in more detail below with reference to FIG. 3. A power supply 116 provides the power to the LED fixture, providing power to the LED units 104 through power supply 108 and also to the cooling fans (not illustrated) and drivers 118. It should be noted that the LED fixture 100 has the same components as a typical LED fixture, but has additional features that will now be described in detail. Specifically, the LED fixture 100 has LEDs units 104 that emit light at a specific wavelength and have a second lens that dictates the beam angle of the light emitted from each of the LED units 104. As used herein, beam angle is used to mean its typical definition—the angle between the between the opposing points on the beam axis where the intensity drops to 50% of its maximum.

Illustrated in FIG. 3 is an enlarged version of an LED unit 104. The LED unit 104 has an LED mounting plate 122, on top of which is the LED mounting area 124. The LED 126 is mounted on the LED substrate 128. Finally, the LED base 130 is where the LED 126 is mounted.

The secondary optics of the invention is generally provided at 120. The arrows show the direction of the light being emitted from the LED 126. The sealed lens 132 is attached to the LED 126 and there is an LED lens 134, which is what changes the beam angle of the LED 126. The beam angles for each of the LED units 104 are specific to the particular wavelength of the light being emitted by the LEDs 126, as discussed in more detail below.

The light from the LED 126 are transmitted by adapting optical properties from the specified lenses 134 in the invention. The LED lenses 134 at each optical surface transmit the light onto plants, which is absorbed by the plants at specific wavelengths or nanometers. The lenses 134 are made from a high grade PMMA. The optical lenses 134 can also be formed to produce different light patterns. The optical lenses 134 are secured in place onto the LED 126 and causes the LED fixture 100 to become a high output light engine.

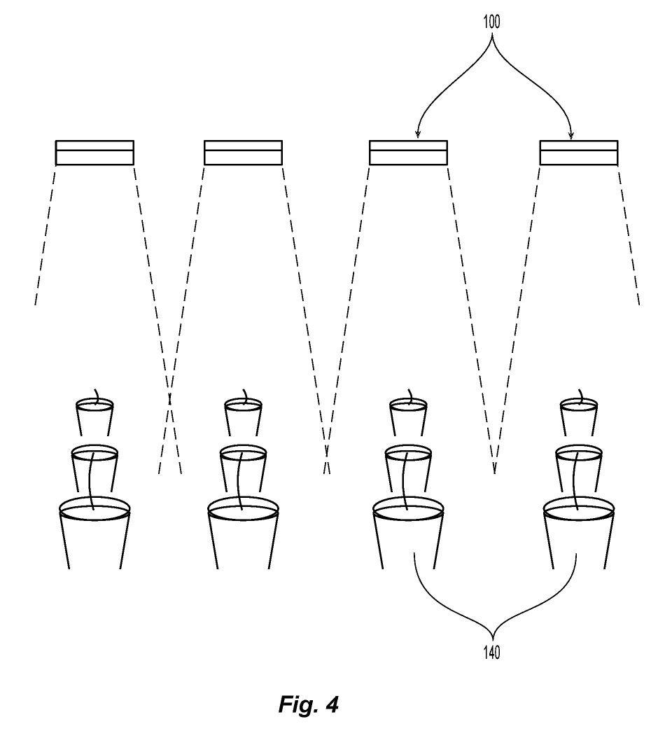

Returning now to the LED fixture 100 and the four sections 102 of LED units 104 in FIG. 1, the use of the LED fixture 100 to accelerate growth of plants will be explained. The LED fixture 100 has four sections 102 of LED units 104, but there could be more or fewer sections 102 as well as more or fewer LED units 104 in each section 102. Typically, there are multiple LED fixtures 100 that would be installed above plants 140 (see, e.g., FIG. 4) and the number of LED fixtures 100 would depend on the size of each of the units, the number of plants 140 being exposed to the light from the LED fixtures 100, etc. The LED fixture 100 also preferably has four on/off switches 150, 152, 154, and 156 which are provided and correspond with each of the plant stages as described below.

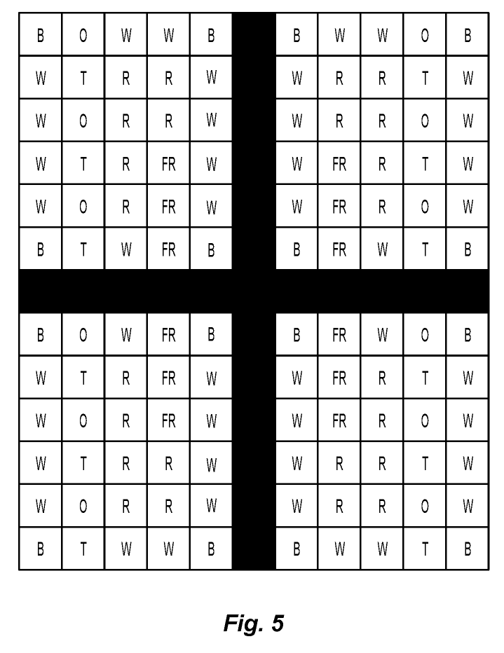

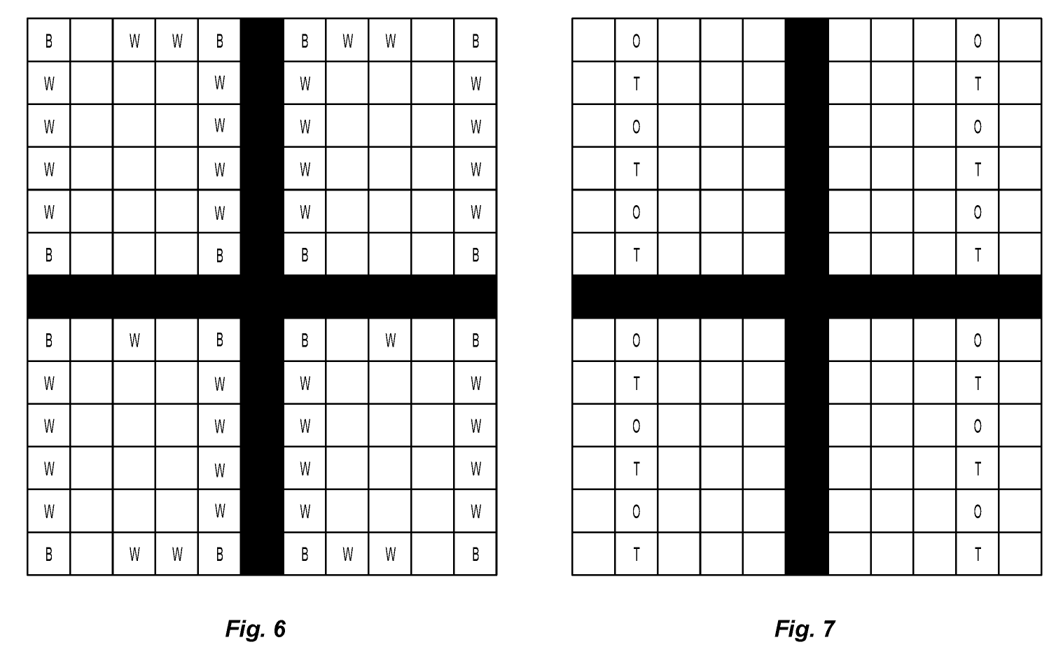

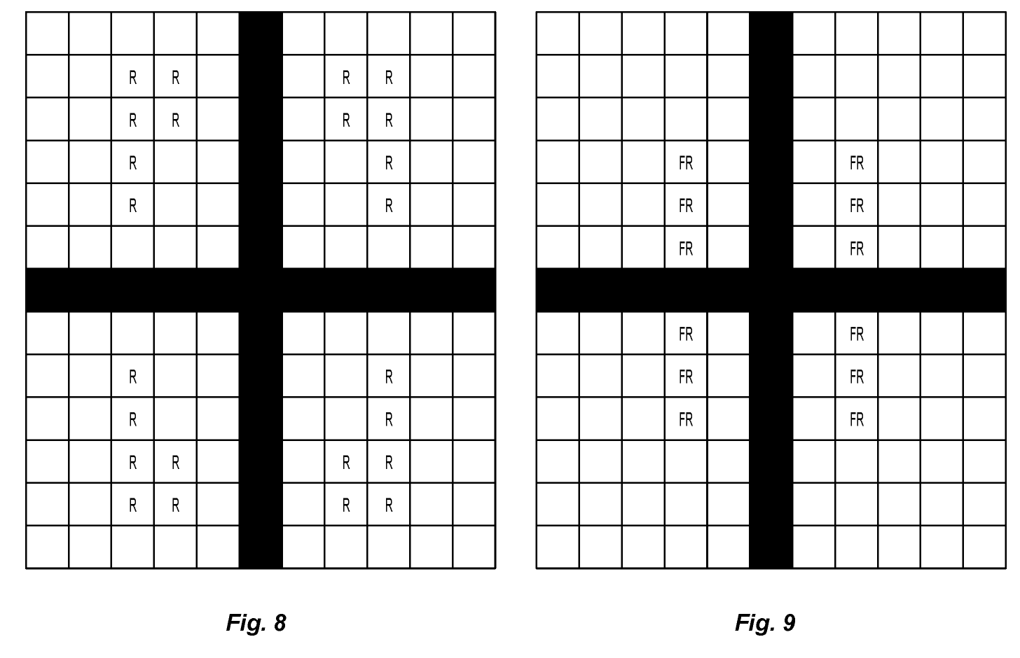

According to one embodiment of the present invention, the LED units 104 may have a number of different colors of light that emitted. Illustrated in FIG. 5 is a representation of the four sections 102 of the LED fixture 100 in FIG. 1. Each of the squares represents one of the LED units 104. For FIG. 5 (and FIGS. 6-9), colors of the light are represented as follows: B=blue; W=white; O=orange; R=red; T=turquoise; and FR=far red or infra red. In one particular embodiment, the colors of the light emitted have specific wavelengths: blue is between about 425 and about 475 nm; orange is between about 600 and about 620 nm; red is between about 635 and about 660 nm; far red or infra red is above about 730 nm; and turquoise is between about 495 and 505 nm. The white light is preferably between 2700 and 6500 Kelvin. More particularly, the colors would have the following wavelengths: blue is 450 nm; orange is 610 nm; red is 660 nm; far red or infra red is above about 730 nm; and turquoise is about 500 nm. It should be noted that the actual wavelengths could be varied somewhat from these specific values and still fall within the scope of the invention. The reason for this is that for the four stages of plant growth (seedling, vegetation, flowering, and budding), the plants exhibit a higher and faster growth rate when provided with certain colors of light. It has been discovered that the plants prefer blue during the seedling phase, orange (and turquoise) during the vegetation stage, red during the flowering stage and far-red or infrared during the budding stage. White light can be used at all times to enhance the specific colors. Thus, as illustrated in FIGS. 6-9, there is provided one example of the different LED units 104 that are turned on during the four phases, respectively. The switch 150 is used to illuminate the LEDs in FIG. 6; switch 152 use to illuminate the LEDs in FIG. 7; switch 154 is used to illuminate the LEDs in FIG. 8; and switch 156 use to illuminate the LEDs in FIG. 9. Additionally, a multi-position on/off switch could be used in place of the switches 150-156.

Turning to FIG. 6 which represents the seedling stage, the blue (B) and the white (W) LEDs 126 are turned on using switch 150. Based on a 90 day cycle, these lights are illuminated over the plants for 12 hours a day for 18 days. In one preferred embodiment, the second switch 152 is then also turned on, so that the lights in FIG. 7, the orange (0) and turquoise (T) are also illuminated over the plants for 16 hours a day for 28 days. After that stage, then the third switch 154 is turned on, adding the lights shown in FIG. 8—the red LEDs (R) are used during the flowering stage and are illuminated with the other three sets for 12 hours a day for 32 days. Finally, during the budding stage, the fourth switch 156 is turned on, illuminating as illustrated in FIG. 9 the far red (FR) LEDs for 10 hours a day for 12 days. At this point in the fourth stage, all of the LEDs 126 are illuminated—a full spectrum. Again, applicant notes that the number of days in each stage as well as the number of hours during each day could be modified from this schedule and still fall within the scope of the present invention. Additionally, during each of the four stages, other wavelengths of light could also be shone on the plants or only those lights for each of the stages, e.g, blue and white during the first stage; orange and turquoise during the second stage; red during the third stage; and the far red during the fourth stage.

The advantage presented by the present invention allows for a number of advantages. First, the fact that LEDs are used to grow plants reduces the amount of energy used as well as the amount of heat produced in providing light to the plants. Second, using light having specific wavelengths further reduces the amount of energy used to grow the plants. For example, in the budding stage, if only far red light is used with the plants, a higher percentage of the light is used by the plant during the stage and the other wavelengths are not being wasted because they are not used by the plants.

As noted above, there can be more or fewer LED units 104 for each of the LED fixtures 100. Additionally, each of the LEDs 126 can have different wattages (e.g., 1, 2, or 5 watts) and their locations relative to the LED fixture 100 or the other LED units 104 could vary, depending on a number of individual considerations (ease of wiring, number of switches, wattage of the LEDs 126, shape of the fixture 100, etc.) One of the major considerations in determining the number of LED units 104 in the wattages of the LEDs 126 is the amount of space inside the LED fixture 100 to accommodate the drivers for the LEDs 126, the heatsinks, and the fans to keep the fixtures cool.

While FIGS. 6-9 illustrate that only some of the LED units 104 may be illuminated during each of the four stages or added sequentially, it is also possible (and in some instances perhaps more desirable) to allow all of the LEDs 126 in each of the sections 102 to remain on at all times. However, in the event that only certain LEDs 126 are to be illuminated during a given stage, a separate on/off switch can be provided to allow for the illumination of the LEDs having the most appropriate wavelengths.

Turning now to the optics of each of the LED units 104, Applicant has determined that the beam angle for each of the colors of the LEDs also affects the growth rate of the plants exposed to the various wavelengths of light. In particular, a 30° beam angle for the orange (about 610 nm) is preferred, while a much wider 120° beam angle for the white and far red (above about 730 nm) is preferred. For the blue light (about 450 nm), a 60° beam angle is preferred, and for the red light (660 nm) a 90° beam angle is preferred.

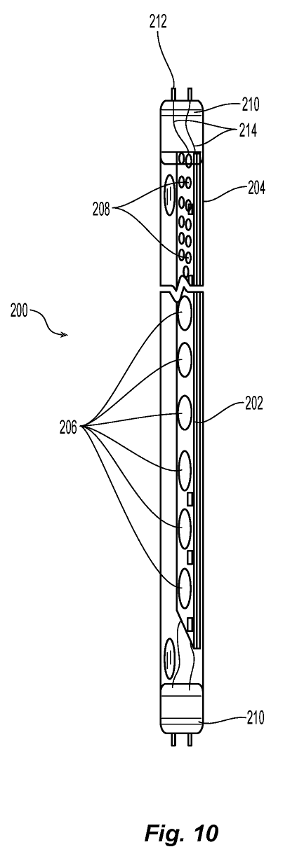

Another embodiment of an LED fixture 200 according to the present invention is illustrated in FIG. 10. In this case, the LEDs are mounted on a substrate 202 that is retrofitted into a fluorescent bulb tube 204. The LED fixture 200 would have some larger LED units 206 (e.g., 5 watt) and then other smaller LEDs 208 (e.g., 1-3 watt). The smaller LEDs 208 do not need to have the optical lenses, but may be added if so desired. Illustrated in FIG. 10, the larger LED units 206 may be assembled at one end and then other smaller LED units 208 are assembled at the other end. However, the LED units 206/208 may be arranged in any arrangement as needed, e.g., by color, size (wattage), etc. As is typical in the industry, the LED fixture 200 has pin brackets 210 that hold pins 212 to make an electrical connection and are in electrical communication with wires 214 to power the LED fixture 200. The LED fixture 200 may be of any length (typically 48″), but is at most 2″ in diameter. In this case, all of the colors would be mounted on the substrate 202 and would be all illuminated at the same time or a full spectrum. Applicant notes that while it may be difficult to put a plurality of switches on these fixtures 200, they may be added in other ways than directly on the fixture. Additionally, LED fixture 200 may not need to have a heat sink and/or fans to dissipate the heat generated by the LEDs.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. An LED lighting fixture for use to accelerate horticultural growth comprising:
a first plurality of LEDs for emitting light having a first color;
a second plurality of LEDs for emitting light having a second color;
a third plurality of LEDs for emitting light having a third color;
a fourth plurality of LEDs for emitting light having a fourth color;
each of the plurality of LEDs having a lens associated therewith, each lens having a beam angle of between 15 and 120 degrees;
LED drivers associated with each of the plurality of LEDs;
at least one heat sink to remove heat from the plurality of LEDs; and
at least one fan to directed to the at least one heat sink.

2. The LED lighting fixture according to claim 1, further comprising a fifth plurality of LEDs for emitting light having a fifth color.

3. The LED lighting fixture according to claim 1, wherein the colors for each of the plurality of LEDs are selected from the group of colors consisting of blue, red, orange, turquoise, far red, and white.

4. The LED lighting fixture according to claim 3, wherein the blue color has a wavelength of about 425 to about 475 nm.

5. The LED lighting fixture according to claim 3, wherein the red color has a wavelength of between about 635 and about 660 nm.

6. The LED lighting fixture according to claim 3, wherein the orange color has wavelength of about 600 to about 620 nm.

7. The LED lighting fixture according to claim 3, wherein the far red color has a wavelength above about 730 nm.

8. The LED lighting fixture according to claim 1, wherein the LEDs are individual LEDs.

9. The LED lighting fixture according to claim 1, wherein at least some of the pluralities of LEDs are provided on a strip.

10. The LED lighting fixture according to claim 1, wherein the beam angle for the LEDs is selected from the group of angles consisting of 30, 60, 90 and 120 degrees.

11. The LED lighting fixture according to claim 1, wherein at least two of the pluralities of LEDs can be turned on at the same time.

12. A method of exposing plants to light to accelerate growth of the plants comprising:
providing a plurality of plants;
providing a plurality of light fixtures, each of the plurality of lighting fixtures comprising a first plurality of LEDs for emitting light having a first color, a second plurality of LEDs for emitting light having a second color, a third plurality of LEDs for emitting light having a third color, and a fourth plurality of LEDs for emitting light having a fourth color, and a fifth plurality of LEDs for emitting white light;
exposing the plants for a first predetermined time period to light from the plurality of light fixtures, the light having a first color;
exposing the plants for a second predetermined time period to light from the plurality of light fixtures, the light having a second color;
exposing the plants for a third predetermined time period to light from the plurality of light fixtures, the light having a third color; and
exposing the plants for a fourth predetermined time period to light from the plurality of light fixtures, the light having a fourth color.

12. The method according to claim 12, where in the first predetermined time period corresponds to a seedling stage of the plants and the light is blue.

13. The method according to claim 12, where in the second predetermined time period corresponds to a vegetation stage of the plants and the light is orange.

14. The method according to claim 12, where in the third predetermined time period corresponds to a flowering stage of the plants and the light is red.

15. The method according to claim 12, where in the fourth predetermined time period corresponds to a budding stage of the plants and the light is far red.

16. The method according to claim 12, wherein the first predetermined time period is 18 days, the second predetermined time period is 28 days, the third predetermined time period is 32 days and the fourth predetermined time period is 12 days.

17. The method according to claim 12, wherein the LEDs are individual LEDs.

18. The method according to claim 12, wherein at least some of the pluralities of LEDs are provided on a strip.
